(19) United States
(12) Patent Application Publication
(10) Pub. No.: US 2006/0094349 A1
(43) Pub. Date: May 4, 2006

(54) Dockable portable satellite receiver

(75) Inventors: Christian H. Slesak, Dearborn Heights, MI (US); Tzu C. Lau, Farmington Hills, MI (US); T.C. Wingrove, Canton, MI (US); Robert J. Burnham, Novi, MI (US); Jack H. King JR., Howell, MI (US); Philip M. Bator, Farmington, MI (US); Martin Thoone, Nuenen (NL); Gary Tkaczyk, Canton, MI (US); Wes Nagara, Commerce Township, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/218,140

(22) Filed: Sep. 1, 2005

Related U.S. Application Data
(60) Provisional application No. 60/620,569, filed on Oct. 20, 2004.

(51) Int. Cl. H04B 1/08

(52) U.S. Cl. 455/3.02; 455/3.06; 455/351

(57) ABSTRACT

A portable satellite receiver includes a tuner, an antenna, and an amplifier. The portable satellite receiver has a protective housing enclosing the tuner, antenna, and amplifier. The portable satellite receiver is configured to interface with an accessory device through a communication link such that the accessory device receives audio signals from the portable satellite receiver over the communication link.

### CROSS-REFERENCE TO RELATED APPLICATIONS

This application claims the benefit of U.S. Provisional Application No. 60/620,569, filed on Oct. 20, 2004, entitled “DOCKABLE MP3/SATELLITE PLAYER FOR AUTOMOTIVE VEHICLES,” the entire contents of which are incorporated herein by reference.

### BACKGROUND

1. Field of the Invention

The present invention generally relates to a portable satellite receiver.

2. Description of Related Art

Currently, satellite radio receivers, such as those offered by XM and Sirius, are used at fixed locations. Whether it is docked in the car or another cradle (e.g. at home via a home entertainment system or a boom box), the receiver unit itself is generally not usable while the receiver is being transported between the boom box and the vehicle. Also, there is no battery power or portable antenna currently on these devices.

Personal music players, such as MP3 players and hereafter referred to as such, have almost the opposite problem. They are useable as a portable device, but have no way of easily and effectively docking or being interfaced with a vehicle. Despite the success of high end players such as iPod (offered by Apple Computers), there are very few ways to safely select and play their content over the speakers of a vehicle's audio system. Currently the only ways to communicate from an MP3 player is via a cassette adapter, an FM modulator (wired or wireless), or a protocol converter. The cassette adapter can only send analog signals (thus lower audio quality) to the audio system's cassette player and can only send data one way (from the MP3 player to the cassette player). An FM modulator also can only send analog signals and can only send data one way to the radio. While protocol converters have been introduced, they only work with specific vehicles and can transmit only limited signals both ways.

To date, interconnecting multimedia devices such as CD players, digital MP3 players/recorders, digital cameras and digital video recorders to transmit data between devices typically uses various physical cables. The use of cables has a few drawbacks.

For example, to connect an MP3 player to the vehicle head unit either an FM modulator, or cassette insert or a direct connection to audio in needs to be done. The interconnections of the various cables/wires are either costly to install or unsightly to the driver and not OEM certified.

As discussed above, one solution might be infrared or FM modulation for wireless data transfer. However, infrared provides a very slow and unreliable connection, and FM modulation does not provide the performance in sound quality of a direct connection.

As a result, there is a need for a direct “cable free” interface/connection between multimedia devices and the head unit to transmit data without the physical limitations or drawbacks of using cables. Also, it will transmit the data at a bandwidth that enhances the multimedia experience.

In view of the above, it is apparent that there exists a need for an improved portable satellite receiver.

### SUMMARY

In satisfying the above need, as well as overcoming the enumerated drawbacks and other limitations of the related art, the present invention provides an improved portable satellite receiver.

The portable satellite receiver described herein provides a dockable and portable device that operates as both a satellite radio receiver and an MP3 player. With the portable satellite receiver, the user can seamlessly listen to music in the car, take the receiver out of the vehicle and listen to it on the go, and then re-dock it at home. Some features of the device include a head unit (single din 50 mm, dual din 100 mm, Gap size radio 120 mm, or other size radios) so that the dockable unit can seamlessly interface with a radio head unit in a vehicle. Other applications and accessories include a home docking station, portable boom box, boat docking system, shower docking system (water proof), and integration with other systems that provide the user audio entertainment.

The abilities of the portable satellite receiver include synching content, recording capabilities (recording data from the internet, from CD, from FM or AM stations), time shifting of data, and an integrated human machine interfaces (HMI). This ability also applies to the feature of recording data/music by a dynamic filtering process. The end user could filter the recording by type of data such as artist, song title, album title, comedy sketch, any news with the specific word “X” in the title, etc. This type of on-demand and filtering of data allows the end user to record content that he or she so desires only. This feature would reduce the specific amount of internal or external memory that is needed. Regarding the latter, the HMI is designed and optimized for different locations and uses. For example, the HMI for the portable satellite receiver in the car is different than the HMI for portable satellite receiver during portable use. Further, the HMI is different for left and right handed people.

According to the present invention, the portable satellite receiver can be docked with a radio head unit, with a home unit, or used as a stand alone device. To support use in the portable mode, the portable satellite receiver has a battery and diversity antenna mounted in the housing of the portable satellite receiver. As a result, digital satellite content can be listened to while on the go (going for a walk, running, outside on the beach, in a moving car, similar usages to what people use portable devices today). Because the satellite portion relies on getting signals from overhead satellites, satellite repeaters (located in some buildings) or land based antennas, the system might not be usable in locations like subways, in tunnels, underground garages, etc. In this environment the user can utilize the MP3 functions for entertainment.

Thus, there is a seamless ability to listen to MP3 recordings or satellite content in a portable fashion. Once at the vehicle, one can dock the portable satellite receiver into the vehicle's head unit and continue to listen to the same content over the car's speaker system. Additionally, a record feature allows time shifting of satellite radio programming by storing it in the player for later playback. Utilizing this feature, the portable satellite receiver will record satellite radio programming while installed in a vehicle equipped with a satellite antenna. The satellite radio programming will be stored in one of the common or future audio formats—such as MP3, and the recorded programming will be played back at a later time. For example, the recorded programming can be played when the portable satellite receiver is undocked from the vehicle/antenna and is in portable mode. For optimum performance, the portable satellite receiver is designed so that it can be easily integrated or docked to an audio system, such that the system can transfer data fully both ways, to and from the portable satellite receiver. The portable satellite receiver would send clear digital signals to the audio system of the vehicle, allowing for better sound quality than current systems and would allow the end user to use the vehicle's HMI interface of the audio system to control the portable device (in vehicle buttons are bigger than aftermarket or consumer electronic devices, which tend to be very small, and are located best for the driver to use the controls while driving so as to minimize driver distraction).

In another aspect of the invention, the portable satellite receiver allows the end user to record music from the vehicle's audio system (CD player, cassette tape, FM, AM, external hard-drive, etc.) onto the portable satellite receiver, so the end user could listen to the content away from the vehicle. As mentioned above, this would allow for time-shifting of content (listening to talk radio at a later time, or listening to the beginning or end of a program or music that was missed). The system would also allow programs over satellite or other systems (FM, AM) to be coded (unique codes within the song itself or in a separate software file that is sent with the data) so the device would automatically or manually recognize the programs and automatic or manually start to record them when the vehicle is on or off. As noted above, today music content is being distributed more and more over non traditional means (less and less people are buying music from stores or in CD format). Many people are receiving music over the internet. Satellite radio provides a good infrastructure for the distribution of this data.

The portable satellite receiver has improved mobility over prior technology, from rechargeable battery technology and a diversity antenna, which gives it the ability to continue to play while being carried and not docked into an associated component. The antenna system would use a diversity antenna which would be built into the housing, headphones, or another location near or on the device, so that the reception would be usable in situations like going for a walk, running, beach, or even sitting in a moving car. The antenna strategy would use the latest technology and the smallest packaging so as to benefit use in a portable device. When the system is used in a vehicle, the satellite antenna could be built into the audio system before hand or would require an extra antenna to be provided (wired or wireless). This also holds true if the device is used in the home (the antenna would be already provided in the home docking unit or an extra line would be wired from the home docking unit to the outside) or other options such as a portable boom box, boating, etc. Using a diversity antenna strategy (does not exist in satellite radio system today), the system would be able to automatically switch to the antenna module that is getting the best reception at that specific moment in time. Another way for the diversity antenna to work is if the system collects the antenna signals from two or more antennas at the same time and use a complex algorithm to combine the two or more signals into one complete and unique satellite signal that would be better than the signals by itself.

The antenna is preferably not seen by the user and may be provided within a typical headset. The antenna, during the portable operation, would not be visible to the end user and the end user would not have to plug or unplug the antenna. This would be done wirelessly or via connectors on the portable satellite receiver that would automatically connect the proper signals and sources from the device to the head unit or docking system (home, auto, etc.). The signals in the connectors would include but not be limited to power, ground, audio L in, audio R in, audio L ground in, audio R ground in, audio R out, audio L out, audio R ground out, audio L ground out, signal 1, signal 2, signal 3, audio 4, audio 5 (for bus/CAN interface protect for future OEM/OES), antenna power, antenna ground, low signal for when the system is on, high signal for when record function is pushed. Preferably, the portable satellite receiver would also have a 2.0 USB interface connection, or other suitable connection, for external computers/internet.

The rechargeable battery pack would use lithium ion, lithium polymer, and/or hydrogen based fuel cell (or future high technology battery storage devices). The unit could be a built in battery source or it would be designed with no battery and instead with the option to insert a battery as an accessory depending on the marketing strategy. If built in, the battery would power the portable satellite receiver during portable operation and would be charging when inserted to a home/automotive/head unit or other docking station/radio.

The portable satellite receiver can be compatible with all music formats (including, but not limited to, WMA, MP3 and AAC) that are popular or desired by the end customers. Alternatively, the player could use a proprietary format and digital rights management (DRM) protected and unprotected songs/data. The portable system can also use external memory options, such as compact flash, SD, memory stick, hard drive, mini-hard drive, etc., if desired.

In addition to the above features, the portable satellite receiver would include components enabling it to record programming from digital satellite or FM radio while in the audio/radio head unit docking station (or other data via the radio, AM, CD, etc.); to time shift (play FM, satellite data, AM content from a different time); record at a specific time on a specific channel or station; record with voice memo or bookmarks; record specific content based on genre, title, author, name or station; and to integrate with a radio head unit docking station.

When integrated into a head unit via a docking feature or an audio system or docking station, once docked, the controls of the audio system will be integrated with the portable satellite receiver. The portable satellite receiver becomes an extension of the audio system and will have the same “look and feel” as player (i.e. HMI); the ability to sync content; the ability to connection to on-line music services; the ability to show different content on the portable satellite receiver screen; all being done without loss of the sound quality that occurs with existing cassette adapter and FM transmitter solutions.

As mentioned above, the HMI would be optimized for auto, home, portable mode, right and left handed people. When the system is docked into a radio head unit, the control button will generally be on the left side, so that the driver of the vehicle can easily use the system. The distance from the driver's right hand (with driver on the left side of the car) is the shortest, if the operation dial or control buttons are closer to the driver. Thus, the dial or buttons need to be located on the left hand side of the portable satellite receiver and/or head unit.

When the system is undocked and used by an end customer in a portable mode of operation, functionality of the controls can automatically change so the dial or other controls can be used on the right hand side of the portable satellite receiver. As such the dial or buttons are reprogrammed so the same features can be used in the same way, but the dials are on the right hand side, or opposite side, of the LCD screen. The LCD screen, or rather its display, once undocked will be automatically flipped so the text and pictures on the LCD screen are upright in relation to the location of the dials. Thus, the player is optimized for end customers that use the system both in the auto and portable options. For left-handed people who prefer the dials on the left side and the LCD screen on the right side of the player there will be an option built into the device so they can manually change the flip-flop or handiness feature. The same would also hold true for vehicles in which the driver sits on the right side of the vehicle.

For OEM/OES automotive uses in which a radio head unit accompanies the portable satellite receiver, the following application could also be employed. For cost sensitive OEMs, the player can have a low cost memory chip built into it and have the radio head unit store a majority of the programming in the radio head memory. Since there is usually more free space in a radio, bigger sized memory can be used. Every time an end user docks the portable satellite receiver into the radio head unit, the radio head unit and the portable satellite receiver can sync as to maximize the limited memory space on the portable device.

The portable satellite receiver is also readily upgradeable. Since technology changes so quickly and the cost of technology also changes very fast, the portable satellite receiver is constructed so one can upgrade the memory very quickly (in production with a memory chip swap or in the field with a memory plug in card). The same holds true for the type of battery used, and type of antenna used. Since the size of the receptacle (where the portable satellite receiver is docked) stays the same for many years (usually in the field for 5-10 years) one can design next generation portable devices so they can be docked into older head units with ease. Interchangeability of the portable satellite receiver allows end customers and OEMs to have a constant upgrade program, consumer electronics to be used by the automotive end customer sooner, and OEMs to offer end customers a base package, midlevel package and premium package, all with the same base radio unit (e.g. a base package audio system and head unit with no add on, a midlevel package with the portable satellite receiver, and a premium package is with a portable satellite receiver and a navigation system.)

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a diagrammatic view of a portable satellite receiver and a docking station in accordance with the present invention;

FIG. 2 is an isometric view of the portable satellite receiver and the docking station in accordance with the present invention;

FIG. 3 is a diagrammatic view of a portable satellite receiver and a docking station with a wireless communication link in accordance with the present invention; and

FIG. 4 is a diagrammatic view of a portable satellite receiver and a headphone unit in accordance with the present invention.

### DETAILED DESCRIPTION

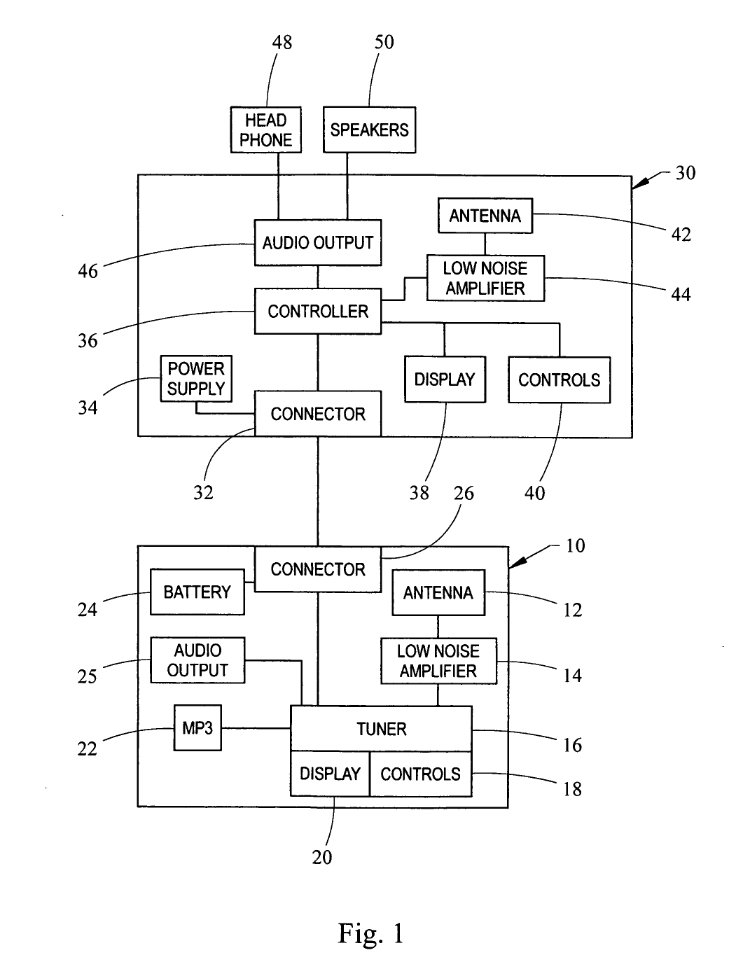

Referring now to FIG. 1, a portable satellite receiver embodying the principles of the present invention is illustrated therein and designated at 10. The portable satellite receiver 10 includes an antenna 12, a tuner 16, a MP3 player 22, and an audio output device 25.

The antenna 12 is a circularly polarized antenna such as a patch, quadra filar helix, or cross-dipole antenna. In a portable application however, a patch antenna will likely be used. The antenna 12 receives a satellite broadcast signal that is communicated to a low noise amplifier 14. The low noise amplifier 14 provides an amplified signal to the tuner 16. The tuner 16 decodes the amplified signal to generate an audio signal that may be provided to an audio output circuit 25. The audio output circuit 25 may include an audio output device such as a speaker or may simply provide a headphone connection. The tuner 16 is also in communication with controls 18 and a display 20. The controls 18 are provided to manipulate tuner parameters including channel selection, volume, base control, and treble control. The display 20 can provide tuner status information to the user or prompt the user for specific input via the controls 18.

The tuner 16 is also in communication with a digital media player such as an MP3 player 22, such that the tuner 16 may receive an audio signal from the MP3 player 22 and provide the signal to the audio output circuit 25. Additionally, the MP3 player 22 may be configured to record audio information from the tuner 16, for later playback. The MP3 player 22 or similar digital media player may have program information tags that store title, artist, album and genre information allowing synchronization of recording and play lists, and selection lists. A battery 24 provides power to each of the previously mentioned components including antenna 12, the low noise amplifier 14, the tuner 16, the controls 18, the display 20, the MP3 player 22, and the audio output circuit 25. The battery 24 may be a lithium ion battery or other power storage device such as a fuel cell. Further, each of the previously mentioned components is contained within and protected by a housing 23. Further, a connector 26 is located on the surface of the housing 23 and configured to interface with other devices, such as a docking station 30. The docking station 30 includes a connector 32 that interfaces with the connector 26 of the portable satellite receiver. Accordingly, the battery 24 and the tuner 16 are in electrical communication with the connector 26 to interface with the docking station 30. A power supply 34 is in communication with connector 32 to provide power to the battery 24.

In addition, a controller 36 is in communication with the connector 32 allowing communication between the controller 36 and the tuner 16. For example, the tuner 16 may provide an audio signal to the controller 36 which may then be provided to an audio output circuit 46. The audio output circuit 46 may be in communication with audio output devices such as headphones 48 or fixed speakers 50. This allows the portable satellite receiver 10 to be used in conjunction with other home entertainment components such as the speakers 50.

A display 38 and controls 40 are in communication with the controller 36 allowing the controls 40 to adjust tuner parameters on the tuner 16 and allowing the tuner 16 to provide display status or other tuner information to the display 38 on the docking station 30. The controls 40 may also facilitate a remote control connection allowing the tuner parameters within the tuner 16 to be manipulated remotely. Further, an antenna 42 is in communication with the controller 36 through a low noise amplifier 44. Accordingly, the docking station 30 may receive a satellite signal via the antenna 42 and generate an amplified signal using the low noise amplifier 44. The amplified signal is provided to the tuner 16 through the controller 38. This could allow a larger, more powerful fixed antenna to provide an improved satellite signal to the tuner 16 while the portable satellite receiver 10 is in communication with the docking station 30.

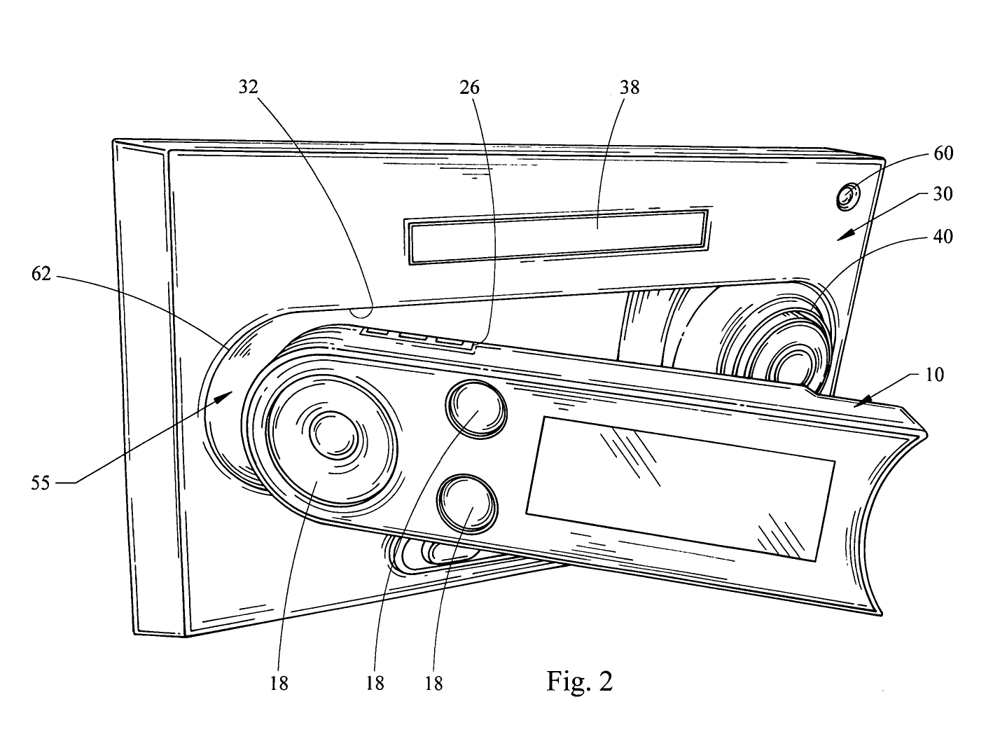

FIG. 2 is an isometric view of the portable satellite receiver 10 and the docking station 30, shown a radio head unit. The portable satellite receiver 10 has a front face 55 that includes the controls 18 and the display 20. Opposite the front face 55, a back face includes a connector 26 (partially shown) that is configured to interface with the docking station 30. The face plate 60 of the docking station 30 includes controls 40 and a display 38. In addition, the face plate 60 includes a recess 62 that is configured to receive the portable satellite receiver 10. As the recess 62 receives a portable satellite player 10, the connector 26 interfaces with a connector 32 located within the recess to conveniently provide communication between the docking station 30 and the portable satellite player 10 as previously described in combination with FIG. 1 above. This provides a cable-less interface between the portable satellite receiver 10 and the docking station 30. The recess 62 acts a receptacle that provides a means of automatically transferring digital media between the portable satellite receiver 10 and the head unit. Control and Display information is given to the portable satellite receiver 10, as well as, power to operate and charge the battery of the portable satellite receiver 10. This interface would also provide hot swapping (connection while the system is running) and automatic power up and power down of the portable satellite receiver 10 based on the status of the docking station 30.

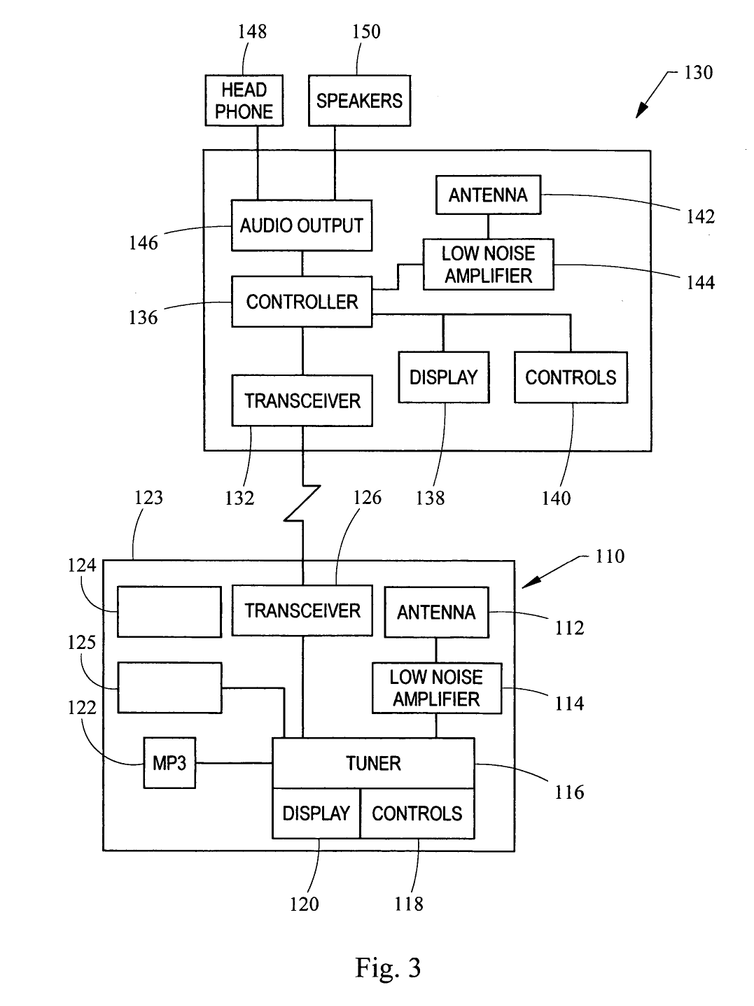

Referring now to FIG. 3, a portable satellite receiver embodying the principles of the present invention is illustrated therein and designated at 110. The portable satellite receiver 110 includes an antenna 112, a tuner 116, a MP3 player 122, and an audio output device 125. The antenna 112 is a circularly polarized antenna, such as a patch, quadra filar helix, or cross-dipole antenna. The antenna 112 receives a satellite broadcast signal that is communicated to a low noise amplifier 114. The low noise amplifier 114 provides an amplified signal to the tuner 116. The tuner 116 decodes the amplified signal to generate an audio signal that may be provided to an audio output circuit 125. The audio output circuit 125 may include an audio output device such as a speaker or may simply provide a headphone connection.

The tuner 116 is also in communication with controls 118 and a display 120. The controls 118 are provided to manipulate tuner parameters including channel selection, volume, base control, and treble control. The display 120 can provide tuner status information to the user or prompt the user for specific input via the controls 118. The tuner 116 is also in communication with an MP3 player such that the tuner 116 may receive input from the MP3 player 122 and provide an audio output to the audio output circuit 125. A battery 124 provides power to each of the previously mentioned components including antenna 112, the low noise amplifier 114, the tuner 116, the controls 118, the display 120, the MP3 player 122, and the audio output circuit 125. The battery 124 may be a lithium ion battery or other power storage device such as a fuel cell.

Each of the previously mentioned components is contained within and protected by a housing 123. Further, a transceiver 126 is located within the housing 123 and configured to communicate with a docking station 130. The transceiver 126 may be a radio frequency transceiver, infra-red transceiver, or any other commonly known wireless transmission means. Accordingly, the tuner 116 is in electrical communication with the transceiver 126 to interface with the docking station 130.

The docking station 130 includes a transceiver 132 that interfaces with the transceiver 126 of the portable satellite receiver 110. In addition, a controller 136 is in communication with the transceiver 132 allowing communication between the controller 136 and the tuner 116. For example, the tuner 116 may provide an audio signal to the controller 136 which may then be provided to an audio output circuit 146. The audio output circuit 146 may be in communication with audio output devices such as headphones 148 or permanently placed speakers 150. Communication between the transceivers 126 and 132 allows the portable satellite receiver 110 to be used in conjunction with other home entertainment components such as the speakers 150.

A display 138 and controls 140 are in communication with the controller 136 allowing the controls 140 to adjust tuner parameters on the tuner 116 and allowing the tuner 116 to provide display status or other tuner information to the display 138 on the docking station 130. Further, an antenna 142 is in communication with the controller 136 through a low noise amplifier 144. Accordingly, the docking station 130 may receive a satellite signal via the antenna 142 and generate an amplified signal through the low noise amplifier 144 that is provided to the tuner 116 through the controller 138. This could allow a larger, more powerful fixed antenna to provide an improved satellite signal to the tuner 116 while the portable satellite receiver 110 is in communication with the docking station 130.

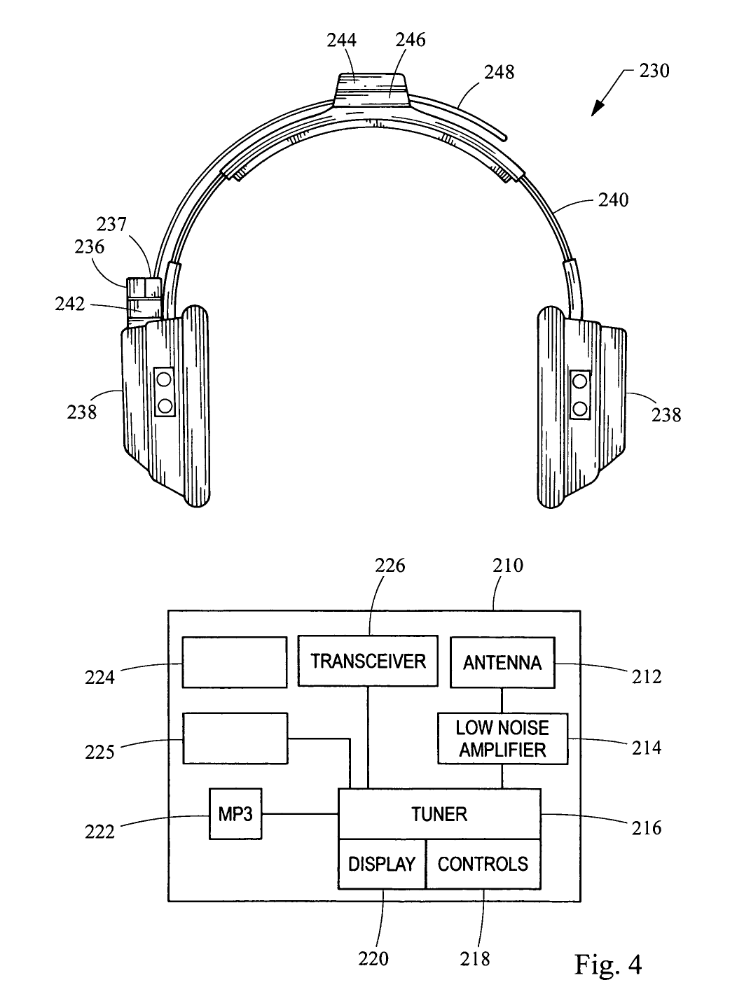

Referring now to FIG. 4, a portable satellite receiver embodying the principles of the present invention is illustrated therein and designated at 210. The portable satellite receiver 210 includes an antenna 212, a tuner 216, a MP3 player 222, and an audio output device 225. The antenna 212 is a circularly polarized antenna and receives a satellite broadcast signal that is communicated to the low noise amplifier 214. A low noise amplifier 214 provides an amplified signal to the tuner 216. The tuner 216 decodes the amplified signal to generate an audio signal that may be provided to an audio output circuit 225. The audio output circuit 225 may include an audio output device such as a speaker or may simply provide a headphone connection. The tuner 216 is also in communication with controls 218 and a display 220. The controls 218 are provided to manipulate tuner parameters including channel selection, volume, base control, and treble control. The display 220 can provide tuner status information to the user or prompt the user for specific input via the controls 218. The tuner 216 is also in communication with an MP3 player 222, such that the tuner 216 may receive input from the MP3 player 222 and provide an audio output to the audio output circuit 225.

A battery 224 provides power to each of the previously mentioned components including antenna 212, the low noise amplifier 214, the tuner 216, the controls 218, the display 220, the MP3 player 222, and the audio output circuit 225. The battery 224 may be a lithium ion battery or other power storage device such as a fuel cell. Further, each of the previously mentioned components is contained within and protected by a housing 223.

The transceiver 226 communicates with a headphone 230 through a transceiver 236. The headphone 230 includes speakers 238, a frame 240, a power supply 242, and an antenna 244. The transceiver 236 receives an audio signal from the portable satellite receiver 210 and provides the audio signal to an audio output circuit 237. The audio output circuit 237 provides the audio signal to the speakers 238 allowing the user to hear the audio from a portable satellite receiver 210. In addition, the headphone 230 may include an antenna 244 to facilitate satellite signal reception. Accordingly, the antenna 244 may be a circularly polarized antenna, such as a patch, quadra filar helix, cross-dipole antenna. The antenna 244 is in communication with a low noise amplifier 246 to generate an amplified signal. The low noise amplifier is in communication with a retransmitting antenna 248, such that the amplified signal is retransmitted via the retransmitting antenna 248 to the antenna 212 in the portable satellite receiver 210. Alternatively, the low noise amplifier may be in communication with the transceiver 236 to communicate the amplified signal to the tuner 216 through the transceiver 266. The retransmitting antenna 248 may be any of the antennas mentioned above or even a straight conductor that is a quarter wavelength of the satellite signal. The straight conductor may be a wire run between two earpieces or alternatively the frame 240 may also serve as the retransmitting antenna, if the frame 240 is in electrical communication with the low noise amplifier 246 to receive the amplified signal. The power supply 242 is in communication with each of the transceiver 226, the audio output circuit 237, the antenna 244, and the low noise amplifier 246. In addition, the power supply 242 may be attached to a power source, such as a solar or gyro powered device.

As a person skilled in the art will readily appreciate, the above description is meant as an illustration of implementation of the principles this invention. This description is not intended to limit the scope or application of this invention in that the invention is susceptible to modification, variation and change, without departing from the spirit of this invention, as defined in the following claims.

I/We claim:

1. A portable satellite receiver comprising a satellite antenna, a satellite tuner, a media player, a display, and user controls, wherein the portable satellite receiver includes a protective housing, the protective housing enclosing the satellite tuner and the media player.

2. The portable satellite receiver according to claim 1, wherein the media player is a digital media player.

3. The portable satellite receiver according to claim 1, wherein the media player is configured to record an audio signal received from the satellite tuner.

4. The portable satellite receiver according to claim 1, wherein the protective housing includes a connector configured to be received by a docking station, thereby allowing two-way communication between the portable satellite receiver and the docking station.

5. The portable satellite receiver according to claim 4, wherein the media player is in communication with the docking station allowing the media player to sync memory with the docking station.

6. The portable satellite receiver according to claim 1, further comprising a wireless transceiver that is in communication with a docking station to allowing syncing of the media player with the docking station.

7. A satellite entertainment system comprising a portable satellite receiver having a tuner, an antenna, and a low noise amplifier, the portable satellite receiver including a protective housing enclosing the tuner, the antenna, and the low noise amplifier;
an accessory device distinct for the portable satellite receiver, the portable satellite receiver being configured to communicate with the accessory device through a communication link, to receive audio signals from the portable satellite receiver.

8. The satellite entertainment system according to claim 7, wherein the satellite receiver has receiver contacts on the outside of the protective housing and the accessory device has a receptacle configured to receive the satellite receiver, the receptacle having receptacle contacts configured to interface with the receiver contacts thereby establishing a communication link between the satellite receiver and the accessory device.

9. The satellite entertainment system according to claim 8, wherein the portable satellite receiver includes a battery electrically connected to the contacts such that the battery can be charged by the accessory device.

10. The satellite entertainment system according to claim 8, wherein the receptacle receives the entire protective housing of the portable satellite receiver.

11. The satellite entertainment system according to claim 7, wherein the accessory device is a headphone.

12. The satellite entertainment system according to claim 11, wherein the communication link is a wireless communication link.

13. The satellite entertainment system according to claim 11, wherein the headphone includes a first headphone antenna to receive a satellite signal.

14. The satellite entertainment system according to claim 11, wherein the headphone includes a second headphone antenna configured to retransmit the satellite signal.

15. The satellite entertainment system according to claim 11, wherein the headphone includes a low noise amplifier connected between the first headphone antenna and the second headphone antenna.

16. The satellite entertainment system according to claim 7, wherein the accessory device includes a user control interface.

17. The satellite entertainment system according to claim 16, wherein the user control interface is configured to control tuner parameters to manipulate the tuner.

18. The satellite entertainment system according to claim 16, wherein the accessory device includes an information display and the portable satellite tuner provides information to the accessory device for display on the information display.

19. The satellite entertainment system according to claim 7, wherein the portable satellite receiver includes a media player in communication with the tuner to provide an audio signal, the media player being enclosed by the protective housing.

20. A device for automotive vehicles comprising:
a head unit including a radio receiver for receiving amplitude or frequency modulated radio signals, said head unit including a receptacle, and
a portable receiver adapted to be received in said receptacle, said portable receiver interfacing with said head unit when received within said receptacle, said portable receiver including storage media to store data in said portable receiver for playback thereby and including a tuner to receive signals transmitted from a satellite for playback thereby, said receiver adapted to store said signals for playback thereof.
